(19) United States
(12) Patent Application Publication
(10) Pub. No.: US 2022/0034308 A1
(43) Pub. Date: Feb. 3, 2022

(54) ELECTROCHEMICAL DEVICE

(71) Applicant: Panasonic Intellectual Property Management Co., Ltd., Osaka (JP)

(72) Inventors: SHIGENORI ONUMA, Kyoto (JP); TAKASHI KAKUWA, Osaka (JP)

(21) Appl. No.: 17/503,450

(22) Filed: Oct. 18, 2021

Related U.S. Application Data
(63) Continuation of application No. PCT/JP2020/040476, filed on Oct. 28, 2020.

(30) Foreign Application Priority Data
Dec. 3, 2019 (JP) 2019-218809
Oct. 9, 2020 (JP) 2020-170915

(51) Int. Cl. F03G 7/00; C25B 13/02; H01M 8/0228; H01M 8/0247; H01M 8/026

(52) U.S. Cl. CPC F03G 7/012; C25B 13/02; H01M 8/026; H01M 8/0247; H01M 8/0228

(57) ABSTRACT

An electrochemical device includes: an electrolyte membrane; an anode disposed on a first main surface of the electrolyte membrane; a cathode disposed on a second main surface of the electrolyte membrane; an anode separator disposed on the anode; and a cathode separator disposed on the cathode and including a first conductive layer on a surface adjacent to the cathode. The cathode includes a cathode gas diffusion layer. The cathode separator has a recess for storing the cathode gas diffusion layer. The first conductive layer is disposed only on a bottom surface of the recess.

### BACKGROUND

### 1. Technical Field

The present disclosure relates to an electrochemical device.

### 2. Description of the Related Art

Renewable energy has recently been replacing fossil fuels, which cause emissions of greenhouse gases, because of global warming concerns. In general, however, renewable energy such as sunlight and wind power is often unstable and dependent on climate change or other factors, so that the electric power generated from renewable energy is not always available when needed.

When there is a surplus of electric power generated from renewable energy, for example, hydrogen is produced using surplus electric power and stored. In this case, hydrogen generation can be carried out in an electrolyzer. Hydrogen storage into a tank can be carried out through an electrochemical hydrogen pump. When there is a shortage of electric power generated from renewable energy, the supply and demand of renewable energy can be kept well-balanced by generation of electric power in a fuel cell using, as fuel, hydrogen stored in a tank.

The generation, storage, and use of hydrogen through use of electric power generated from renewable energy to create a clean hydrogen society require involvement of various electrochemical devices, such as fuel cells, electrolyzers, and electrochemical hydrogen pumps. These electrochemical devices thus have been developed for many years.

For example, Japanese Unexamined Patent Application Publication No. 2007-280636 (PTL 1) proposes a technique for increasing the strength and corrosion resistance of separators for polymer electrolyte fuel cells. Specifically, grooves through which gas flows are disposed on a main surface of a metal substrate of a separator. A resin layer containing a conductive material, such as carbon particles, is formed over the entire surface of the metal substrate by electrodeposition. A gas diffusion layer is integrated with the metal substrate so as to cover the grooves of the metal substrate. This configuration can increase the strength and corrosion resistance of the separator.

### SUMMARY

However, PTL 1 has not sufficiently studied the cost reduction of separators for electrochemical devices.

One non-limiting and exemplary embodiment provides an electrochemical device that may be less expensive in terms of the cost of separators than that in the related art.

In one general aspect, the techniques disclosed here feature an electrochemical device including an electrolyte membrane, an anode disposed on a first main surface of the electrolyte membrane, a cathode disposed on a second main surface of the electrolyte membrane, an anode separator disposed on the anode, and a cathode separator disposed on the cathode and including a first conductive layer on a surface adjacent to the cathode, wherein the cathode includes a cathode gas diffusion layer, the cathode separator has a recess for storing the cathode gas diffusion layer, and the first conductive layer is disposed only on a bottom surface of the recess.

An electrochemical device in an aspect of the present disclosure has an advantage of lower separator cost than that in the related art.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a view of an example electrochemical hydrogen pump according to an embodiment;

FIG. 2A is an enlarged view of the portion IIA of the electrochemical hydrogen pump in FIG. 1;

FIG. 2B is a view of an example anode separator in an electrochemical hydrogen pump in Example 1 according to the embodiment and is an enlarged view of the portion IIB in FIG. 1;

FIG. 2C is a view of an example cathode separator in an electrochemical hydrogen pump in Example 2 according to the embodiment and is an enlarged view of the portion IIC in FIG. 1; and

FIG. 3 is a view of an example electrochemical hydrogen pump according to Modification of the embodiment.

### DETAILED DESCRIPTION

The following findings are made by studying the cost reduction of separators for electrochemical devices.

In PTL 1, the entire surface of the metal substrate of the separator is coated with the resin layer containing a conductive material, such as carbon particles, by electrodeposition, as described above. Specifically, the inner surfaces of the grooves, which do not distribute to the reduction in contact resistance between the gas diffusion layer and the metal substrate of the fuel cell, are also coated with the resin layer. The side surfaces of the metal substrate, which do not face the gas diffusion layer, are also coated with the resin layer. The fuel cell disclosed in PTL 1 has an issue of high separator cost due to consumption of the material of such a resin layer.

An electrochemical device in a first aspect of the present disclosure includes an electrolyte membrane, an anode disposed on a first main surface of the electrolyte membrane, a cathode disposed on a second main surface of the electrolyte membrane, an anode separator disposed on the anode, and a cathode separator disposed on the cathode and including a first conductive layer on a surface adjacent to the cathode, wherein the cathode includes a cathode gas diffusion layer, the cathode separator has a recess for storing the cathode gas diffusion layer, and the first conductive layer is disposed only on a bottom surface of the recess.

According to this configuration, the electrochemical device in this aspect may be less expensive in terms of the cost of the cathode separator than that in the related art.

Specifically, the first conductive layer is disposed only on a region of the surface of the cathode separator that faces the cathode and contributes to the reduction in contact resistance between the cathode gas diffusion layer and the cathode separator in the electrochemical device in this aspect. The electrochemical device in this aspect can reduce the coating cost of the first conductive layer compared with the related art while appropriately reducing an increase in contact resistance between the cathode gas diffusion layer and the cathode separator.

When the electrochemical device is, for example, a device that releases a high-pressure cathode gas from the cathode to the outside, the cathode separator may have a recess for storing the cathode gas diffusion layer. In this case, the gas pressure in the cathode gas diffusion layer increases during operation of the electrochemical device. This eliminates the need of a channel groove on the bottom surface of the recess of the cathode separator. By providing a communication hole at an appropriate position in the cathode separator, the cathode gas can be released from the electrochemical device to the outside, The inside of the recess communicates with the outside of the recess through the communication hole. The above operational advantage can be obtained by providing the first conductive layer only on the bottom surface of the recess of the cathode separator in the electrochemical device in this aspect.

According to an electrochemical device in a second aspect of the present disclosure, in the electrochemical device as set forth in the first aspect, the cathode separator may have a second conductive layer on a surface opposite to the cathode.

The following findings are made by studying the improvement of the durability and reliability of electrochemical devices.

In PTL 1, the metal substrate is coated with the resin layer containing a conductive material, such as carbon particles, by electrodeposition. However, the intensive studies carried out by the inventors of the present disclosure have found that the resin layer having electrical conductivity described in PTL 1 may have uneven thickness, pinholes, or the like. This may be because, when the resin layer is formed on the main surface of the metal substrate having a recess and protrusion for the channel groove as in PTL 1, the recess and protrusion easily cause uneven thickness, pinholes, or the like in the resin layer. An electrochemical device having this metal substrate thus tends to have disadvantages in terms of durability and reliability. For example, upon application of a desired voltage to the separator having the gas diffusion layer in the electrochemical device, the current unevenly flows between the gas diffusion layer and the separator because of the uneven thickness of the conductive layer. This may lead to overheating of the electrochemical device due to heat generation caused by current concentration or may lead to electrode degradation associated with overvoltage due to fuel shortage in the current-concentrated area to compromise durability. This may degrade the durability and reliability of the electrochemical device.

According to an electrochemical device in a third aspect of the present disclosure, in the electrochemical device as set forth in the first aspect or the second aspect, the first conductive layer may be formed by diffusion bonding of a sheet provided with a conductive material of the first conductive layer to a substrate sheet of the cathode separator.

According to this configuration, the first conductive layer having more uniform thickness, smaller flatness, and smaller surface roughness than that in the related art can be integrally formed on the substrate sheet of the cathode separator in the electrochemical device in this aspect. This is because there is no recess or protrusion for the channel groove on the sheet to be provided with the conductive material of the first conductive layer.

In the electrochemical device in this aspect an appropriate contact area is thus ensured between the cathode separator and the cathode gas diffusion layer by disposing the first conductive layer having uniform thickness, small flatness, and small surface roughness in the cathode separator. This configuration can suppress an increase in contact resistance between the cathode separator and the cathode gas diffusion layer in the electrochemical device in this aspect and can reduce the durability and reliability of the device.

According to an electrochemical device in a fourth aspect of the present disclosure, in the electrochemical device as set forth in any one of the first to third aspects, a third conductive layer may be disposed on a surface of the anode separator adjacent to the anode, and the third conductive layer may be disposed only on a region of the surface of the anode separator that faces the anode.

According to this configuration, the electrochemical device in this aspect may be less expensive in terms of the cost of anode separators than that in the related art.

Specifically, the third conductive layer is disposed only on a region of the surface of the anode separator that faces the anode and contributes to the reduction in contact resistance between the anode gas diffusion layer and the anode separator in the electrochemical device in this aspect. The electrochemical device in this aspect can reduce the coating cost of the third conductive layer compared with the related art while appropriately reducing an increase in contact resistance between the anode gas diffusion layer and the anode separator.

According to an electrochemical device in a fifth aspect of the present disclosure, in the electrochemical device as set forth in the fourth aspect the anode separator has a recess and protrusion on a main surface adjacent to the anode, and the third conductive layer is disposed only on a portion of the protrusion that faces the anode.

In the electrochemical device, the anode separator may have, in the main surface, a channel groove in the form of recess through which fluid used for electrochemical reactions is uniformly supplied to the diffusion layer. In this case, the main surface of the diffusion layer is not in contact with the inner surface of the channel groove (recess). The above operational advantage can be obtained by providing the third conductive layer only on a protrusion of the anode separator that faces the anode in the electrochemical device in this aspect.

According to an electrochemical device in a sixth aspect of the present disclosure, in the electrochemical device as set forth in the fourth aspect or the fifth aspect, the third conductive layer may be formed by diffusion bonding of a sheet provided with a conductive material of the third conductive layer to a substrate sheet of the anode separator.

According to this configuration, the electrochemical device in this aspect may have higher durability and higher reliability than that in the related art.

In other words, the third conductive layer having more uniform thickness, smaller flatness, and smaller surface roughness than that in the related art can be integrally formed on the substrate sheet of the anode separator in the electrochemical device in this aspect, This is because the sheet to be provided with the conductive material of the third conductive layer has an opening for the channel groove, and the conductive material of the third conductive layer is disposed in an area other than the opening.

In the electrochemical device in this aspect, an appropriate contact area is thus ensured between the anode separator and the anode gas diffusion layer by disposing the third conductive layer having uniform thickness, small flatness, and small surface roughness in the anode separator, This configuration can suppress an increase in contact resistance between the anode separator and the anode gas diffusion layer in the electrochemical device in this aspect and can reduce the durability and reliability of the device.

An embodiment of the present disclosure will be described below with reference to the attached drawings. The embodiment described below illustrates examples of the aspects described above. The shapes, materials, and components, and the arrangement positions and connection configuration of the components described below are illustrative only and should not be construed as limiting the aspects unless otherwise mentioned in Claims. Among the components described below, the components that are not mentioned in the independent claim indicating the broadest concept of each aspect are described as optional components. Redundant description of the components assigned with the same reference characters in the drawings may be avoided. Each component is schematically illustrated in the drawings for easy understanding, and the shape, the dimensional ratio, and the like may not be accurately depicted.

### Embodiment

In the electrochemical device, the anode fluid in the anode and the cathode fluid in the cathode may be various gases or liquids. For example, when the electrochemical device is an electrochemical hydrogen pump, the anode fluid may be a hydrogen-containing gas, For example, when the electrochemical device is an electrolyzer, the anode fluid may be water vapor or liquid water. For example, when the electrochemical device is a fuel cell, the anode fluid and the cathode fluid may be a hydrogen-containing gas and an oxidant gas, respectively.

In the following embodiment, the structure and operation of an electrochemical hydrogen pump, an example electrochemical device, where the anode fluid is a hydrogen-containing gas will be described.

### Device Structure

### General Structure of Electrochemical Hydrogen Pump

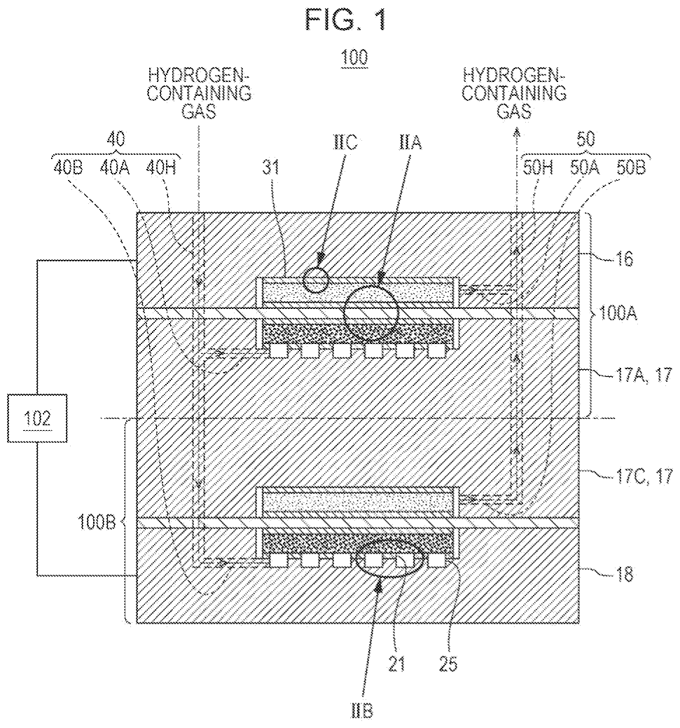

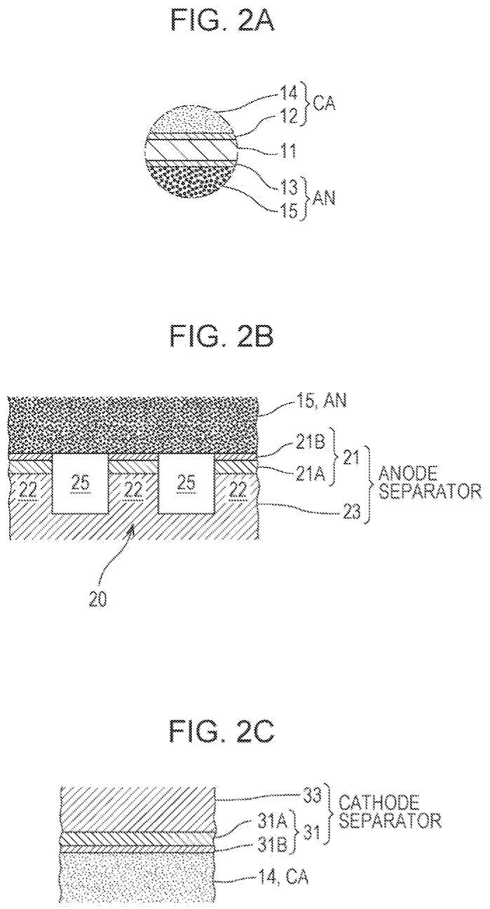

FIG. 1 is a view of an example electrochemical hydrogen pump according to an embodiment. FIG. 2A is an enlarged view of the portion IIA of the electrochemical hydrogen pump in FIG. 1.

Referring to FIG. 1, an electrochemical hydrogen pump 100 includes a hydrogen pump unit 100A and a hydrogen pump unit 100B. The hydrogen pump unit 100A is disposed above the hydrogen pump unit 100B.

FIG. 1 illustrates two hydrogen pump units: the hydrogen pump unit 100A and the hydrogen pump unit 1003; however, the number of hydrogen pump units is not limited to this example. In other words, the number of hydrogen pump units can be set to an appropriate number on the basis of, for example, the operation conditions such as the amount of hydrogen pressurized in the cathode CA of the electrochemical hydrogen pump 100,

The hydrogen pump unit 100A includes an electrolyte membrane 11, an anode AN, a cathode CA, a first cathode separator 16, and an intermediate separator 17. The hydrogen pump unit 100B includes an electrolyte membrane 11, an anode AN, a cathode CA, the intermediate separator 17, and a first anode separator 18. The intermediate separator 17 functions as the anode separator of the hydrogen pump unit 100A and also functions as the cathode separator of the hydrogen pump unit 100B. In other words, in the electrochemical hydrogen pump 100 according to this embodiment, the anode separator of the hydrogen pump unit 100A is integrated with the cathode separator of the hydrogen pump unit 1003; however, the present disclosure is not limited to this structure. Although not shown in the figure, the anode separator may be separate from the cathode separator. For easy understanding, a portion of the intermediate separator 17 that functions as the anode separator is referred to as a second anode separator 17A. A portion of the intermediate separator 17 that functions as the cathode separator is referred to as a second cathode separator 17C.

Referring to FIG. 2A, the anode AN is disposed on a first main surface of the electrolyte membrane 11. The anode AN is an electrode including an anode catalyst layer 13 and an anode gas diffusion layer 15.

The cathode CA is disposed on a second main surface of the electrolyte membrane 11. The cathode CA is an electrode including a cathode catalyst layer 12 and a cathode gas diffusion layer 14.

In the hydrogen pump unit 100A and the hydrogen pump unit 100B as described above, the electrolyte membrane 11 is sandwiched between the anode AN and the cathode CA in such a manner that the anode catalyst layer 13 and the cathode catalyst layer 12 are each in contact with the electrolyte membrane 11. A cell including the cathode CA, the electrolyte membrane 11, and the anode AN is referred to as a membrane electrode assembly (hereinafter MEA).

Between the first cathode separator 16 and the second anode separator 17A and between the second cathode separator 17C and the first anode separator 18, the electrolyte membrane 11 is disposed and an annular seal member (not shown) is sandwiched so as to surround the periphery of the MEA in plan view. An annular flat insulator may be disposed between the first cathode separator 16 and the second anode separator 17A and between the second cathode separator 17C and the first anode separator 18.

This configuration prevents short-circuiting between the first cathode separator 16 and the second anode separator 17A and short-circuiting between the second cathode separator 17C and the first anode separator 18.

### Structure of MEA

The electrolyte membrane 11 has proton conductivity. The electrolyte membrane 11 may have any structure as long as it has proton conductivity. Examples of the electrolyte membrane 11 include, but are not limited to, fluoropolymer electrolyte membranes and hydrocarbon polymer electrolyte membranes. Specifically, for example, Nafion (registered trademark, available from DuPont) or Aciplex (registered trademark, available from Asahi Kasei Corporation) can be used as the electrolyte membrane 11.

The anode catalyst layer 13 is disposed on the first main surface of the electrolyte membrane 11. The anode catalyst layer 13 contains, for example, platinum as a catalyst metal; however, the catalyst metal is not limited to platinum.

The cathode catalyst layer 12 is disposed on the second main surface of the electrolyte membrane 11. The cathode catalyst layer 12 contains, for example, platinum as a catalyst metal; however, the catalyst metal is not limited to platinum.

Examples of the catalyst support in the cathode catalyst layer 12 and the anode catalyst layer 13 include, but are not limited to, a carbon powder made of, for example, carbon black or graphite, and a conductive oxide powder.

In the cathode catalyst layer 12 and the anode catalyst layer 13, the fine particles of the catalyst metal are densely dispersed and supported on the catalyst support. To increase the electrode reaction area, an ionomer component having proton conductivity is typically added to the cathode catalyst layer 12 and the anode catalyst layer 13.

The cathode gas diffusion layer 14 is disposed on the cathode catalyst layer 12. The cathode gas diffusion layer 14 is made of a porous material and has electrical conductivity and gas diffusibility. The cathode gas diffusion layer 14 preferably has elasticity so as to appropriately accommodate displacement and deformation of components caused by a difference in pressure between the cathode CA and the anode AN during operation of the electrochemical hydrogen pump 100. In the electrochemical hydrogen pump 100 according to this embodiment, a member made of carbon fiber is used as the cathode gas diffusion layer 14. For example, a porous carbon fiber sheet, such as carbon paper, carbon cloth, or carbon felt, may be used, It is not necessary to use a carbon fiber sheet as a substrate of the cathode gas diffusion layer 14, The substrate of the cathode gas diffusion layer 14 may be, for example, a sintered compact of metal fiber made of titanium, a titanium alloy, stainless steel, or other material, or a sintered compact of metal powder made of any of these material.

The anode gas diffusion layer 15 is disposed on the anode catalyst layer 13. The anode gas diffusion layer 15 is made of a porous material and has electrical conductivity and gas diffusibility. The anode gas diffusion layer 15 preferably has high rigidity so as to prevent or reduce displacement and deformation of components caused by a difference in pressure between the cathode CA and the anode AN during operation of the electrochemical hydrogen pump 100.

In the electrochemical hydrogen pump 100 according to this embodiment, the anode gas diffusion layer 15 is a member formed of a thin plate of titanium powder sintered compact; however, the anode gas diffusion layer 15 is not limited to this member, In other words, the substrate of the anode gas diffusion layer 15 may be, for example, a sintered compact of metal fiber made of titanium, a titanium alloy, stainless steel, or other material, or a sintered compact of metal powder made of any of these materials, or may be a carbon porous body. The substrate of the anode gas diffusion layer 15 may be, for example, expanded metal, metal mesh, or punched metal,

### Structure of Anode Separator

The first anode separator 18 is a conductive member disposed on the anode AN of the hydrogen pump unit 100B. Specifically, the first anode separator 18 has, in a central area of the main surface, a recess for storing the anode gas diffusion layer 15 of the hydrogen pump unit 100B,

The second anode separator 17A is a conductive member disposed on the anode AN of the hydrogen pump unit 100A. Specifically, the second anode separator 17A has, in a central area of the main surface, a recess for storing the anode gas diffusion layer 15 of the hydrogen pump unit 100A.

The first anode separator 18 and the second anode separator 17A may each be a substrate sheet made of metal, such as titanium, SUS316, or SUS316L; however, the present disclosure is not limited to such a substrate sheet.

The first anode separator 18 and the second anode separator 17A each have a third conductive layer 21 on the surface adjacent to the anode AN. The third conductive layer 21 is disposed only on a region of the surface of each of the first anode separator 18 and the second anode separator 17A that faces the anode AN, The details of the structure of the third conductive layer 21 will be described in Example 1.

### Structure of Cathode Separator

The first cathode separator 16 is a conductive member disposed on the cathode CA of the hydrogen pump unit 100A. Specifically, the first cathode separator 16 has, in a central area of the main surface, a recess for storing the cathode gas diffusion layer 14 of the hydrogen pump unit 100A.

The second cathode separator 17C is a conductive member disposed on the cathode CA of the hydrogen pump unit 1008. Specifically, the second cathode separator 17C has, in a central area of the main surface, a recess for storing the cathode gas diffusion layer 14 of the hydrogen pump unit 1008.

The first cathode separator 16 and the second cathode separator 17C may each be a substrate sheet made of metal, such as titanium, SUS316, or SUS316L; however, the present disclosure is not limited to such a substrate sheet.

The first cathode separator 16 and the second cathode separator 17C each have a first conductive layer 31 on the surface adjacent to the cathode CA. The first conductive layer 31 is disposed only on a region of the surface of each of the first cathode separator 16 and the second cathode separator 17C that faces the cathode CA. The details of the structure of the first conductive layer 31 will be described in Example 2.

As described above, the hydrogen pump unit 100A is formed by sandwiching the MEA between the first cathode separator 16 and the second anode separator 17A. The hydrogen pump unit 1008 is formed by sandwiching the MEA between the first anode separator 18 and the second cathode separator 17C.

Referring to FIG. 1, the first anode separator 18 in contact with the anode gas diffusion layer 15 has a recess and protrusion 20 (see FIG. 2B) on a main surface adjacent to the anode AN, and the recess forms an anode gas channel groove 25. The second anode separator 17A in contact with the anode gas diffusion layer 15 has a recess and protrusion 20 (see FIG. 2B) on a main surface adjacent to the anode AN, and the recess forms an anode gas channel groove 25.

The anode gas channel groove 25 has, for example, a serpentine shape including multiple U-shaped turns and multiple straight lines in plan view. However, the anode gas channel groove 25 is illustrative, and the present disclosure is not limited to this example. For example, the anode gas channel may be formed of multiple straight channels.

### Structure of Voltage Applicator

Referring to FIG. 1, the electrochemical hydrogen pump 100 includes a voltage applicator 102.

The voltage applicator 102 is a device that applies a voltage between the anode catalyst layer 13 and the cathode catalyst layer 12. Specifically, a high potential of the voltage applicator 102 is applied to the anode catalyst layer 13, and a low potential of the voltage applicator 102 is applied to the cathode catalyst layer 12. The voltage applicator 102 may have any structure as long as it can apply a voltage between the anode catalyst layer 13 and the cathode catalyst layer 12. For example, the voltage applicator 102 may be a device that regulates the voltage applied between the anode catalyst layer 13 and the cathode catalyst layer 12. Specifically, the voltage applicator 102 includes a DC/DC converter when being connected to a direct-current power supply, such as a battery, a solar cell, or a fuel cell, or includes an AC/DC converter when being connected to an alternating-current power supply, such as a commercial power supply.

The voltage applicator 102 may be, for example, an electric power-type power supply that regulates the voltage applied between the anode catalyst layer 13 and the cathode catalyst layer 12 and the current flowing between the anode catalyst layer 13 and the cathode catalyst layer 12 in such a manner that the electric power supplied to the electrochemical hydrogen pump 100 becomes a predetermined value.

Although not shown in the figure, a terminal of the voltage applicator 102 on the low potential side is connected to a cathode power supply plate, and a terminal of the voltage applicator 102 on the high potential side is connected to an anode power supply plate. The cathode power supply plate is disposed at, for example, the first cathode separator 16 of the hydrogen pump unit 100A. The anode power supply plate is disposed at, for example, the first anode separator 18 of the hydrogen pump unit 100B. The cathode power supply plate and the anode power supply plate are in electrical contact with the first cathode separator 16 and the first anode separator 18, respectively.

As described above, the electrochemical hydrogen pump 100 is a device in which application of the above voltage with the voltage applicator 102 causes hydrogen in a hydrogen-containing gas supplied onto the anode catalyst layer 13 to move onto the cathode catalyst layer 12 and pressurizes the hydrogen. In the electrochemical hydrogen pump 100, protons (H⁺) separated from the hydrogen-containing gas in the anode AN move to the cathode CA through the electrolyte membrane 11, generating a hydrogen-containing gas in the cathode CA. The hydrogen-containing gas is, for example, a high-pressure hydrogen gas containing water vapor discharged from the cathode CA.

The electrochemical hydrogen pump 100 includes an anode gas supply passage 40 through which a hydrogen-containing gas is supplied to the anode AN from the outside and a cathode gas discharge passage 50 through which the hydrogen-containing gas is discharged from the cathode CA to the outside. The details of the structure of these passages will be described below.

### Fastened Structure of Electrochemical Hydrogen Pump

Referring to FIG. 1 and FIG. 2A, the first cathode separator 16, the intermediate separator 17, and the first anode separator 18 are stacked in this order in the same direction as the stacking direction of the anode gas diffusion layer 15, the anode catalyst layer 13, the electrolyte membrane 11, the cathode catalyst layer 12, and the cathode gas diffusion layer 14 in the electrochemical hydrogen pump 100.

Although not shown in the figure, for example, a first end plate having high rigidity is disposed on the outer surface of the first cathode separator 16 of the electrochemical hydrogen pump 100 with a first insulating plate therebetween. In addition, for example, a second end plate having high rigidity is disposed on the outer surface of the first anode separator 18 of the electrochemical hydrogen pump 100 with a second insulating plate therebetween.

A fastener (not shown) fastens the members of the electrochemical hydrogen pump 100, the first insulating plate, the first end plate, the second insulating plate, and the second end plate in the stacking direction described above.

The fastener may have any structure as long as it can fasten these members in the stacking direction.

Examples of the fastener include bolts and disc spring nuts.

The bolt of the fastener may penetrate only the first end plate and the second end plate, or the bolt may penetrate the members of the electrochemical hydrogen pump 100, the first insulating plate, the first end plate, the second insulating plate, and the second end plate. The fastener applies a desired fastening pressure to the electrochemical hydrogen pump 100 in such a manner that the end surface of the first cathode separator 16 and the end surface of the first anode separator 18 are sandwiched between the first end plate and the second end plate with the first insulating plate between the first end plate and the end surface of the first cathode separator 16 and with the second insulating plate between the second end plate and the end surface of the first anode separator 18.

When the bolt of the fastener penetrates the members of the electrochemical hydrogen pump 100, the first insulating plate, the first end plate, the second insulating plate, and the second end plate, the members of the electrochemical hydrogen pump 100 are appropriately kept stacked in the stacking direction under the fastening pressure of the fastener. In addition, the members of the electrochemical hydrogen pump 100 can be appropriately prevented from moving in the in-plane direction since the bolt of the fastener penetrates the members of the electrochemical hydrogen pump 100.

In the electrochemical hydrogen pump 100 according to this embodiment, the members are accordingly stacked and integrated in the staking direction by using the fastener.

### Structure of Hydrogen-Containing Gas Passage

An example of the structure of the channel for supplying the hydrogen-containing gas to the anode AN of the electrochemical hydrogen pump 100 will be described below with reference to FIG. 1. In FIG. 1, the flow of the hydrogen-containing gas is schematically illustrated by thin dash-dotted line arrows.

Referring to FIG. 1, the electrochemical hydrogen pump 100 includes the anode gas supply passage 40.

The anode gas supply passage 40 includes, for example, a vertical channel 40H, a first horizontal channel 40A, and a second horizontal channel 40B, which communicate with each other. The vertical channel 40H is located at an appropriate position in members of the electrochemical hydrogen pump 100 and extends in the vertical direction. The first horizontal channel 40A and the second horizontal channel 408 are respectively located at appropriate positions in the second anode separator 17A and the first anode separator 18 and extend in the horizontal direction. Specifically, the vertical channel 40H communicates with the anode AN of the hydrogen pump unit 100A through the first horizontal channel 40A in the second anode separator 17A. For example, the first horizontal channel 40A may be connected to an end of the anode gas channel groove 25 having a serpentine shape in the second anode separator 17A. The vertical channel 40H communicates with the anode AN of the hydrogen pump unit 1003 through the second horizontal channel 40B in the first anode separator 18. For example, the second horizontal channel 408 may be connected to an end of the anode gas channel groove 25 having a serpentine shape in the first anode separator 18.

According to the above structure, the hydrogen-containing gas from the outside flows through the vertical channel 40H, the first horizontal channel 40A, and the anode AN of the hydrogen pump unit 100A in this order and flows through the vertical channel 40H, the second horizontal channel 40B, and the anode AN of the hydrogen pump unit 100B in this order, as indicated by dash-dotted line arrows in FIG. 1. In other words, the hydrogen-containing gas in the vertical channel 40H splits so as to flow into both the first horizontal channel 40A and the second horizontal channel 408. The hydrogen-containing gas is supplied to the electrolyte membranes 11 through the anode gas diffusion layers 15.

Next, an example of the structure of the channel for discharging the hydrogen-containing gas from the cathode CA of the electrochemical hydrogen pump 100 to the outside will be described below with reference to FIG. 1. In FIG. 1, the flow of the hydrogen-containing gas is schematically illustrated by thin dash-dotted line arrows.

Referring to FIG. 1, the electrochemical hydrogen pump 100 includes the cathode gas discharge passage 50,

The cathode gas discharge passage 50 includes, for example, a vertical channel 50H, a first horizontal channel 50A, and a second horizontal channel 50B, which communicate with each other. The vertical channel 50H is located at an appropriate position in members of the electrochemical hydrogen pump 100 and extends in the vertical direction. The first horizontal channel 50A and the second horizontal channel 50B are respectively located at appropriate positions in the first cathode separator 16 and the second cathode separator 17C and extend in the horizontal direction. Specifically, the vertical channel 50H communicates with the cathode CA of the hydrogen pump unit 100A through the first horizontal channel 50A in the first cathode separator 16. The vertical channel 50H communicates with the cathode CA of the hydrogen pump unit 100B through the second horizontal channel 50B in the second cathode separator 17C.

According to the above structure, the high-pressure hydrogen-containing gas pressurized in the cathode CA of the hydrogen pump unit 100A flows through the first horizontal channel 50A and the vertical channel 50H in this order, as indicated by the dash-dotted line arrows in FIG. 1. The hydrogen-containing gas is then discharged from the electrochemical hydrogen pump 100. The high-pressure hydrogen-containing gas pressurized in the cathode CA of the hydrogen pump unit 100B flows through the second horizontal channel 50B and the vertical channel 50H in this order, as indicated by the dash-dotted line arrows in FIG. 1. The hydrogen-containing gas is then discharged from the electrochemical hydrogen pump 100. In other words, the hydrogen-containing gas in the first horizontal channel 50A and the hydrogen-containing gas in the second horizontal channel 50B meet in the vertical channel 50H.

The structure of the electrochemical hydrogen pump 100 is illustrative, and the present disclosure is not limited to this example. For example, the electrochemical hydrogen pump 100 may include, at an appropriate position, an anode gas discharge passage (not shown) through which part of the hydrogen-containing gas is discharged from the anode gas channel grooves 25, instead of having a dead-end structure in which the total amount of hydrogen in the hydrogen-containing gas supplied to the anode gas channel grooves 25 of the hydrogen pump unit 100A and the hydrogen pump unit 100B is pressurized. Steady operation consumes about 80% or at most about 90% of hydrogen in the hydrogen-containing gas supplied from the anode gas channel groove 25, and the unconsumed hydrogen-containing gas is discharged from the hydrogen pump unit 100A through the anode gas discharge passage (not shown). The unconsumed hydrogen-containing gas is recycled and mixed with the newly supplied hydrogen-containing gas, and the mixed gas is then supplied to the anode gas supply passage 40 of the hydrogen pump unit 100A again.

### Operation

An example of the operation of the electrochemical hydrogen pump 100 according to this embodiment will be described below with reference to the drawings.

The following operation may be performed by, for example, an arithmetic circuit of a controller (not shown) reading a control program from a memory circuit of the controller. However, the following operation is not necessarily performed by the controHer. An operator may operate part of the operation.

First, a low-pressure hydrogen-containing gas is supplied to the anode AN of the electrochemical hydrogen pump 100, and the voltage of the voltage applicator 102 is applied to the electrochemical hydrogen pump 100. The electrochemical hydrogen pump 100 involves a hydrogen pressurizing operation in which protons separated from the hydrogen-containing gas supplied to the anode AN move to the cathode CA through the electrolyte membrane 11 to generate pressurized hydrogen. Specifically, in the anode catalyst layer 13 of the anode AN, a hydrogen molecule dissociates into protons and electrons (formula (1)). The protons are conducted through the electrolyte membrane 11 to the cathode catalyst layer 12. The electrons move to the cathode catalyst layer 12 through the voltage applicator 102. In the cathode catalyst layer 12, a hydrogen molecule is generated again (formula (2)). It is known that a predetermined amount of water serving as electroosmosis water moves from the anode AN to the cathode CA together with protons when protons are conducted through the electrolyte membrane 11.

Anode: H₂ (low pressure)→2H⁺+2e⁻ (1)

Cathode: 2H⁺2e⁻→H₂ (high pressure) (2)

The hydrogen-containing gas generated in the cathode CA of the electrochemical hydrogen pump 100 is pressurized in the cathode CA. For example, the hydrogen-containing gas can be pressurized in the cathode CA by increasing the pressure drop in a cathode gas outlet passage by using a flow rate regulator (not shown). Examples of the flow rate regulator include a back pressure valve or regulator valve provided at the cathode gas outlet passage.

Here, reducing the pressure drop in the cathode gas outlet passage using the flow rate regulator at an appropriate time causes the hydrogen-containing gas to be discharged from the cathode CA of the electrochemical hydrogen pump 100 to the outside through the cathode gas discharge passage 50. Reducing the pressure drop in the cathode gas outlet passage using the flow rate regulator refers to increasing the degree of opening of a valve, such as a back pressure valve or a regulator valve.

Hydrogen supplied through the cathode gas outlet passage is temporarily stored in, for example, a hydrogen reservoir (not shown). The hydrogen stored in the hydrogen reservoir is supplied to a hydrogen receptor at an appropriate time. Examples of the hydrogen receptor include fuel cells, which generate electric power by using hydrogen.

As described above, the electrochemical hydrogen pump 100 according to this embodiment may be less expensive in terms of the cost of the anode separators than that in the related art.

Specifically, the third conductive layer 21 is disposed only on a region of the surface of each of the first anode separator 18 and the second anode separator 17A (hereinafter, anode separators) that faces the anode AN and contributes to the reduction in contact resistance between the anode gas diffusion layer 15 and the corresponding anode separator in the electrochemical hydrogen pump 100 according to this embodiment. The electrochemical hydrogen pump 100 according to this embodiment can reduce the coating cost of the third conductive layer 21 compared with the related art while appropriately reducing an increase in contact resistance between the anode gas diffusion layer 15 and the corresponding anode separator.

As described above, the electrochemical hydrogen pump 100 according to this embodiment may be less expensive in terms of the cost of the cathode separators than that in the related art.

Specifically, the first conductive layer 31 is disposed only on a region of the surface of each of the first cathode separator 16 and the second cathode separator 17C (hereinafter, cathode separators) that faces the cathode CA and contributes to the reduction in contact resistance between the cathode gas diffusion layer 14 and the corresponding cathode separator in the electrochemical hydrogen pump 100 according to this embodiment. The electrochemical hydrogen pump 100 according to this embodiment can reduce the coating cost of the first conductive layer 31 compared with the related art while appropriately reducing an increase in contact resistance between the cathode gas diffusion layer 14 and the corresponding cathode separator.

### EXAMPLE 1

An electrochemical hydrogen pump 100 according to Example 1 is the same as the electrochemical hydrogen pump 100 according to the embodiment except the structure of the anode separators described below.

FIG. 2B is a view of an example of the anode separator in the electrochemical hydrogen pump in Example 1 according to the embodiment and is an enlarged view of the portion IIB in FIG. 1.

FIG. 2B illustrates the portion IIB of the first anode separator 18 of the hydrogen pump unit 100B. The second anode separator 17A of the hydrogen pump unit 100A has the same structure as the first anode separator 18 of the hydrogen pump unit 100B, and the illustration and description of the second anode separator 17A are thus omitted.

As shown in FIG. 2B, the anode separator has the recess and protrusion 20 on a main surface adjacent to the anode AN, and the third conductive layer 21 is disposed only on a portion of a protrusion 22 of the anode separator that faces the anode AN. The third conductive layer 21 is formed by diffusion bonding of a sheet 21A provided with a conductive material 21B of the third conductive layer 21 to a substrate sheet 23 of the anode separator.

A specific example of the anode separator will be described below in detail with reference to the drawings.

In the electrochemical hydrogen pump 100 according to Example 1, for example, the substrate sheet 23 having a thickness equal to or greater than 2 mm and made of stainless steel (e.g., SUS316 or SUS316L) or titanium is integrated with the sheet 21A having a thickness of about 0.1 to 0.5 mm and made of stainless steel or titanium through diffusion bonding. This configuration eliminates voids in the joint between the substrate sheet 23 and the sheet 21A and can thus reduce the contact resistance of the electrochemical hydrogen pump 100. During operation of the electrochemical hydrogen pump 100, for example, a high pressure of about 1 MPa to 82 MPa is applied between the cathode CA and the anode AN. In Example 1, the substrate sheet 23 of the anode separator is formed of a stainless steel plate having a thickness equal to or greater than 2 mm. This configuration allows the anode separator to have appropriate rigidity.

The substrate sheet 23 of the anode separator has the anode gas channel groove 25 having a serpentine shape in plan view. The anode gas channel groove 25 is formed by, for example, producing the recess and protrusion 20 in sectional view by etching or cutting the main surface of the substrate sheet 23. Only a portion of the protrusion 22 of the substrate sheet 23 that faces the anode AN is integrated with a first main surface of the sheet 21A through diffusion bonding.

In other words, in the electrochemical hydrogen pump 100, the anode separator has, in the main surface, the anode gas channel groove 25 in the form of recess in sectional view, through which the hydrogen-containing gas used for electrochemical reactions is uniformly supplied to the anode gas diffusion layer 15. In this case, the main surface of the anode gas diffusion layer 15 is not in contact with the inner surface of the anode gas channel groove 25 but in contact with only the protrusion 22 through the third conductive layer 21.

A second main surface of the sheet 21A has a coating of the conductive material 21B having a thickness less than or equal to 1 μm (e.g., about 0.001 μm to 0.1 μm). The coating of the conductive material 21B has high electrical conductivity and high corrosion resistance, and the anode gas diffusion layer 15 is disposed on this coating. In other words, the third conductive layer 21 having high electrical conductivity and high corrosion resistance is preferably disposed only in a region of the anode separator that is in contact with the anode gas diffusion layer 15. The coating of the conductive material 21B can be formed by depositing the conductive material 21B on the sheet 21A by using an appropriate film forming method, such as physical vapor deposition.

Examples of the conductive material 21B include, but are not limited to, diamond-like carbon, graphite, and graphene.

For example, the sheet 21A having the coating of the conductive material 21B (the third conductive layer 21) can be easily blanked out, with an appropriate press die, from a commercial coat material manufactured by using rolling-mill rolls. For example, a commercial coat material may be cut into a circular shape having a diameter of about 80 mm to 130 mm by pressing the commercial coat material so as to have an opening corresponding to the anode gas channel groove 25 having a serpentine shape in plan view, and the coat material having a circular shape may be then diffusion-bonded to the substrate sheet 23.

Although not shown in the figure, an oxide coating having high corrosion resistance may be formed in a region of the anode separator that has no third conductive layer 21. The oxide coating may be, for example, a passive film formed on the surface of stainless steel or titanium.

The structure of the anode separator and the method for producing the anode separator are illustrative, and the present disclosure is not limited to this example.

As described above, the third conductive layer 21 is disposed only on a portion of the protrusion 22 of the anode separator that faces the anode AN in the electrochemical hydrogen pump 100 according to Example 1. This configuration can reduce the coating cost of the third conductive layer 21 compared with the related art while appropriately reducing an increase in contact resistance between the anode gas diffusion layer 15 and the anode separator.

In PTL 1, the metal substrate is coated with the resin layer containing a conductive material, such as carbon particles, by electrodeposition. However, the intensive studies carried out by the inventors of the present disclosure have found that the resin layer having electrical conductivity described in PTL 1 may have uneven thickness, pinholes, or the like. This may be because, when the resin layer is formed on the main surface of the metal substrate having a recess and protrusion for the channel groove as in PTL 1, the recess and protrusion easily cause uneven thickness, pinholes, or the like in the resin layer. An electrochemical device having this metal substrate thus tends to have disadvantages in terms of durability and reliability. For example, upon application of a desired voltage to the separator having the gas diffusion layer in the electrochemical device, the current unevenly flows between the gas diffusion layer and the separator because of the uneven thickness of the conductive layer. This may lead to overheating of the electrochemical device due to heat generation caused by current concentration or may lead to electrode degradation associated with overvoltage due to fuel shortage in the current-concentrated area to compromise durability. This may degrade the durability and reliability of the electrochemical device.

In the electrochemical hydrogen pump 100 according to Example 1, the third conductive layer 21 is formed by diffusion bonding of the sheet 21A provided with the conductive material 21B of the third conductive layer 21 to the substrate sheet 23 of the anode separator.

According to this configuration, the electrochemical hydrogen pump 100 in Example 1 may have higher durability and higher reliability than that in the related art. In other words, the third conductive layer 21 having more uniform thickness, smaller flatness, and smaller surface roughness than that in the related art can be integrally formed on the substrate sheet 23 of the anode separator in the electrochemical hydrogen pump 100 according to Example 1. This is because the sheet 21A has an opening for the channel groove, and the conductive material 21B of the third conductive layer 21 is disposed in an area other than the opening.

In the electrochemical hydrogen pump 100 according to Example 1, an appropriate contact area is thus ensured between the anode separator and the anode gas diffusion layer 15 by disposing the third conductive layer 21 having uniform thickness, small flatness, and small surface roughness in the anode separator. This configuration can suppress an increase in contact resistance between the anode separator and the anode gas diffusion layer 15 in the electrochemical hydrogen pump 100 in this aspect and can reduce the durability and reliability of the device.

The electrochemical hydrogen pump 100 according to Example 1 may be the same as the electrochemical hydrogen pump 100 according to the embodiment except the above features.

### EXAMPLE 2

An electrochemical hydrogen pump 100 according to Example 2 is the same as the electrochemical hydrogen pump 100 according to the embodiment except the structure of the cathode separator described below.

FIG. 2C is a view of an example cathode separator in the electrochemical hydrogen pump in Example 2 according to the embodiment and is an enlarged view of the portion IIC in FIG. 1,

FIG. 2C illustrates the portion IIC of the first cathode separator 16 of the hydrogen pump unit 100A. The second cathode separator 17C of the hydrogen pump unit 100B has the same structure as the first cathode separator 16 of the hydrogen pump unit 100A, and the illustration and description of the second cathode separator 17C are thus omitted.

The cathode separator has a recess for storing the cathode gas diffusion layer 14 as shown in FIG. 1, and the first conductive layer 31 is disposed only on the bottom surface of the recess. As shown in FIG. 2C, the first conductive layer 31 is formed by diffusion bonding of a sheet 31A provided with a conductive material 31B of the first conductive layer 31 to a substrate sheet 33 of the cathode separator.

A specific example of the cathode separator will be described below in detail with reference to the drawings.

In the electrochemical hydrogen pump 100 according to Example 2, for example, the substrate sheet 33 having a thickness equal to or greater than 2 mm and made of stainless steel (e.g., SUS316 or SUS316L) or titanium is integrated with the sheet 31A having a thickness of about 0.1 to 0.5 mm and made of stainless steel or titanium through diffusion bonding. This configuration eliminates voids in the joint between the substrate sheet 33 and the sheet 31A and can thus reduce the contact resistance of the electrochemical hydrogen pump 100.

The substrate sheet 33 of the cathode separator has a recess for storing the cathode gas diffusion layer 14. The recess is formed by, for example, etching or cutting the main surface of the substrate sheet 33. Only the bottom surface of the recess of the substrate sheet 33 is integrated with a first main surface of the sheet 31A through diffusion bonding.

In other words, the gas pressure in the cathode gas diffusion layer 14 increases during operation of the electrochemical hydrogen pump 100. This eliminates the need of a channel groove on the bottom surface of the recess of the substrate sheet 33 of the cathode separator. By providing a communication hole at an appropriate position in the substrate sheet 33, the hydrogen-containing gas can be released from the electrochemical hydrogen pump 100 to the outside. The inside of the recess communicates with the outside of the recess through the communication hole. In this case, the main surface of the cathode gas diffusion layer 14 may be, for example, in surface contact with the entire bottom surface of the recess of the substrate sheet 33 of the cathode separator.

A second main surface of the sheet 31A has a coating of the conductive material 31B having a thickness less than or equal to 1 (e.g., about 0.001 μm to 0.1 μm). The coating of the conductive material 31B has high electrical conductivity and high corrosion resistance, and the cathode gas diffusion layer 14 is disposed on this coating. In other words, the first conductive layer 31 having high electrical conductivity and high corrosion resistance is preferably disposed only in a region of the cathode separator that is in contact with the cathode gas diffusion layer 14. The coating of the conductive material 31B can be formed by depositing the conductive material 31B on the sheet 31A by using an appropriate film forming method, such as physical vapor deposition.

Examples of the conductive material 31B include, but are not limited to, diamond-like carbon, graphite, and graphene.

For example, the sheet 31A having the coating of the conductive material 31B (the first conductive layer 31) can be easily blanked out, with an appropriate press die, from a commercial coat material manufactured by using rolling-mill rolls. For example, a commercial coat material may be cut into a circular shape having a diameter of about 80 mm to 130 mm by pressing the commercial coat material, and the coat material having a circular shape may be then diffusion-bonded to the substrate sheet 33.

Although not shown in the figure, an oxide coating having high corrosion resistance may be formed in a region of the cathode separator that has no first conductive layer 31. The oxide coating may be, for example, a passive film formed on the surface of stainless steel or titanium.

The structure of the cathode separator and the method for producing the cathode separator are illustrative, and the present disclosure is not limited to this example.

As described above, the first conductive layer 31 is disposed only on the bottom surface of the recess of the cathode separator in the electrochemical hydrogen pump 100 according to Example 2. This configuration can reduce the coating cost of the first conductive layer 31 compared with the related art while appropriately reducing an increase in contact resistance between the cathode gas diffusion layer 14 and the cathode separator.

The intensive studies carried out by the inventors of the present disclosure have found that the electrochemical device in PTL 1 may have low durability and low reliability.

In the electrochemical hydrogen pump 100 according to Example 2, the first conductive layer 31 is formed by diffusion bonding of the sheet 31A provided with the conductive material 31B of the first conductive layer 31 to the substrate sheet 33 of the cathode separator.

According to this configuration, the electrochemical hydrogen pump 100 in Example 2 may have higher durability and higher reliability than that in the related art. In other words, the first conductive layer 31 having more uniform thickness, smaller flatness, and smaller surface roughness than that in the related art can be integrally formed on the substrate sheet 33 of the cathode separator in the electrochemical hydrogen pump 100 according to Example 2. This is because there is no recess or protrusion for the channel groove on the sheet 31A to be provided with the conductive material 31B of the first conductive layer 31.

In the electrochemical hydrogen pump 100 according to Example 2, an appropriate contact area is thus ensured between the cathode separator and the cathode gas diffusion layer 14 by disposing the first conductive layer 31 having uniform thickness, small flatness, and small surface roughness in the cathode separator. This configuration can suppress an increase in contact resistance between the cathode separator and the cathode gas diffusion layer 14 in the electrochemical hydrogen pump 100 in this aspect and can reduce the durability and reliability of the device.

The electrochemical hydrogen pump 100 according to Example 2 may be the same as the electrochemical hydrogen pump 100 according to the embodiment except the above features.

### Modification

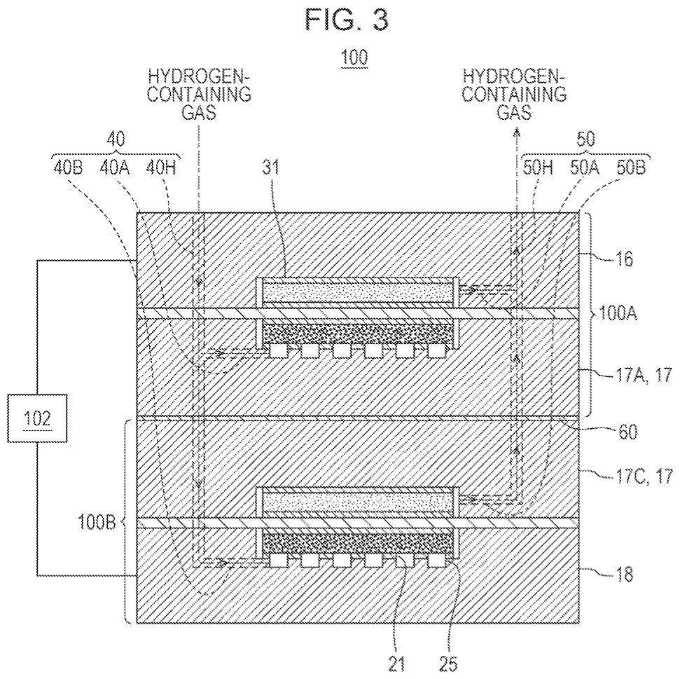

FIG. 3 is a view of an example electrochemical hydrogen pump according to Modification of the embodiment.

An electrochemical hydrogen pump 100 according to Modification is the same as the electrochemical hydrogen pump 100 according to the embodiment except that a second conductive layer 60 is disposed on the surface of the cathode separator opposite to the cathode CA. Specifically, in the electrochemical hydrogen pump 100 according to Modification, the second conductive layer 60 is disposed between the anode separator of the hydrogen pump unit 100A and the cathode separator of the hydrogen pump unit 100B, and these members may be integrated with one another. For example, the substrate sheet of the anode separator and the cathode separator may be integrated with the sheet made of stainless steel or titanium through diffusion bonding. In the electrochemical device according to Modification, the second conductive layer 60 having more uniform thickness, smaller flatness, and smaller surface roughness than that in the related art can thus be integrally formed on the substrate sheet of the anode separator and the cathode separator.

The electrochemical hydrogen pump 100 according to Modification may be the same as the electrochemical hydrogen pump 100 according to any one of the embodiment, Example 1 of the embodiment, and Example 2 of the embodiment except the above features.

The embodiment, Example 1 of the embodiment, Example 2 of the embodiment, and Modification of the embodiment may be combined with one another unless they exclude one another.

From the above description, many improvements and other embodiments of the present disclosure are apparent to those skilled in the art. Therefore, the above description should be construed as illustrative only and is provided for the purpose of teaching those skilled in the art the best modes for carrying out the present disclosure. The details of the structure and/or function of the present disclosure can be substantially modified without departing from the spirit of the present disclosure.

For example, the MEA, the anode separator, and the cathode separator in the electrochemical hydrogen pump 100 according to the embodiment can be used as an MEA, an anode separator, and a cathode separator in other electrochemical devices, such as electrolyzers and fuel cells,

One aspect of the present disclosure can be applied to an electrochemical device that may be less expensive in terms of the cost of separators.

What is claimed is:

1. An electrochemical device comprising:
an electrolyte membrane;
an anode disposed on a first main surface of the electrolyte membrane;
a cathode disposed on a second main surface of the electrolyte membrane;
an anode separator disposed on the anode; and
a cathode separator disposed on the cathode and including a first conductive layer on a surface adjacent to the cathode,
wherein the cathode includes a cathode gas diffusion layer;
the cathode separator has a recess for storing the cathode gas diffusion layer, and
the first conductive layer is disposed only on a bottom surface of the recess.

2. The electrochemical device according to claim 1, wherein the cathode separator has a second conductive layer on a surface opposite to the cathode.

3. The electrochemical device according to claim 1, wherein the first conductive layer is formed by diffusion bonding of a sheet provided with a conductive material of the first conductive layer to a substrate sheet of the cathode separator.

4. The electrochemical device according to claim 1;
wherein a third conductive layer is disposed on a surface of the anode separator, the surface being adjacent to the anode, and
the third conductive layer is disposed only on a region of the surface of the anode separator, the region facing the anode.

5. The electrochemical device according to claim 4, wherein the anode separator has a recess and protrusion on a main surface adjacent to the anode;
and the third conductive layer is disposed only on a portion of the protrusion, the portion facing the anode.

6. The electrochemical device according to claim 4, wherein the third conductive layer is formed by diffusion bonding of a sheet provided with a conductive material of the third conductive layer to a substrate sheet of the anode separator.
